(19) United States
(12) Patent Application Publication
(10) Pub. No.: US 2003/0084001 A1
(43) Pub. Date: May 1, 2003

(54) System and method for managing and securing transaction information via a third party

(75) Inventor: Chia-Chi Chang, Taipei (TW)

Correspondence Address: TROXELL LAW OFFICE PLLC, SUITE 1404, 5205 LEESBURG PIKE, FALLS CHURCH, VA, 22041, US

(73) Assignee: NetBuck Payment Service Co., Ltd.

(21) Appl. No.: 10/028,820

(22) Filed: Dec. 28, 2001

(30) Foreign Application Priority Data
Oct. 31, 2001 (TW) 90127038

(51) Int. Cl. G06F 17/60

(52) U.S. Cl. 705/64; 705/78

(57) ABSTRACT

The present invention provides a data processing system for managing and securing a transaction information via a third party. The transaction information comprises a first information associated with a seller and a second information associated with a buyer. The system comprises a first and a second processing apparatuses operated by the third party and the seller, respectively. The first processing apparatus is used for encrypting the second information based on the first information to generate an encrypted second information, and transmitting the first information and the encrypted second information. The second processing apparatus links to the first processing apparatus, stores the first information and the encrypted second information transmitted from the first processing apparatus, and transmits the first information and the encrypted second information back to the first processing apparatus when the seller requests to check the transaction. When the first processing apparatus receives the first information and the encrypted second information from the second processing apparatus, it decrypts the encrypted second information based on the first information to retrieve the transaction information, generates a response information responsive to the request, and transmits the response information to the second processing apparatus. Thus, the transaction information is prevented from being altered by the seller.

### FIELD OF THE INVENTION

The present invention relates to a system and method for managing and securing transaction information, and more particularly, to a system and method for managing and securing transaction information via a third party.

### BACKGROUND OF THE INVENTION

People's lifestyle continues to improve as technology advances. The invention of Internet has brought the way of communication into a new era, which sharply reduces time and space between people. Especially, Internet provides unprecedented convenience for shopping. In the past, it took consumer lots of time and effort to search for something they want with lowest prices. It is often consumer's effort turn out in vain. With the blooming of Internet; however, people can world widely browse websites to look for their ideal products effortlessly and goods selected can be delivered to home via logistics service providers. As a result, it saves consumers lots of time and extends their consumption abroad without physical traveling.

On the other hand, Internet has its downside on privacy protection even if it is so convenient. While purchasing online; for example, consumer has to provide personal information, such as personal account, PIN and credit card number. The information asked will then send to issuing banks to request authorization for completion of transaction made. It is possible at the moment of transmission that hackers may intercept information given for illegal purposes or consumer could, unfortunately, run into some e-shops where the merchants falsely treat the information received.

Accordingly, it is an objective of the present invention to provide a system and method for managing and securing transaction information via a third party. It is noted that the fair third party manages and secures the transaction information but will not be involved in the transaction itself. More specifically, the encryption and decryption of the private information associated with buyer (consumer) are not executed by seller (merchant), but executed by the fair third party. In addition, consumer's information will be protected from being used illegally by merchant, and after all, consumer's interest and rights will be protected as well.

### SUMMARY OF THE INVENTION

It is an objective of the present invention to provide a system and method for managing and securing transaction information via a third party. The fair third party manages and secures the transaction information but is not involved in the transaction. More specifically, the encryption and decryption of the private information associated with buyer (consumer) are not executed by seller (merchant), but executed by the third party. Thus, the present invention can prevent the merchant from using consumer's information illegally.

According to a preferred embodiment of the present invention, a data processing system is for managing and securing transaction information associated with a transaction via a third party. Such transaction is conducted between a buyer and a seller. The transaction information comprises a first information associated with the selling party and a second information associated with the buying party. The data processing system comprises a first processing apparatus and a second processing apparatus. The third party operates the first processing apparatus. The seller operates the second processing apparatus. The first processing apparatus is used for encrypting the second information based on the first information to generate an encrypted second information, and transmitting the first information and the encrypted second information out. The second processing apparatus is linked to the first processing apparatus for storing the first information. The encrypted second information is transmitted from the first processing apparatus. The second processing apparatus transmits the first information and the encrypted second information back to the first processing apparatus when the seller requests to check the transaction. When the first information and the encrypted second information are transmitted back and received by the first processing apparatus, the first processing apparatus decrypts the encrypted second information based on the first information to retrieve the transaction information. According to the retrieved transaction information, the first processing apparatus generates responsive information to reply checking request on the transaction, and transmits the responsive information to the second processing apparatus. Therefore, the present invention can prevent the transaction information from being altered by the seller.

A data processing method executed by the data processing system according to the present invention comprises the steps of encrypting the second information based on the first information to generate an encrypted second information on the third party; transmission of the first information and the encrypted second information from the third party to the seller, and storage of the first information and the encrypted second information on the seller; reception from the seller a request on checking the transaction information; accession of the first information and the encrypted second information from the seller to the third party; decryption of the encrypted second information based on the first information to retrieve the transaction information on the third party; generation of a responsive information to reply request information on the third party according to the retrieved information; and transmission of the responsive information to the seller. Therefore, the present invention can prevent the transaction information from being altered by the seller.

These and other objectives of the present invention will obviously become more understandable after the practical examples are detailed described and illustrated by various figures and drawings in the following paragraph.

### BRIEF DESCRIPTION OF THE APPENDED DRAWINGS

FIG. 1 is a schematic diagram of a data processing system according to the preferred embodiment of the present invention.

FIG. 2A is a schematic diagram of the unencrypted transaction information.

FIG. 2B is a schematic diagram of the encrypted transaction information.

FIG. 3 is a flow chart of the data processing procedures according to a preferred embodiment of the present invention.

### DETAILED DESCRIPTION OF THE INVENTION

After a transaction is completed, it is necessary for seller (merchant) to store transaction log for later auditing purpose; thus, it is seller's responsibility to keep transaction records in a good information management manner. As transaction models vary and get complicated nowadays, buyer and seller are not the only two parties who conduct a transaction process, but so is a third party, such as account transfer, payment and/or authorization institutions, that might get involved as well. As a result, storage of each transaction log between seller, buyer and third party mentioned as above will be an obligation after completion of each transaction for either audition or double-checking purposes. Moreover, it is possible that some merchant falsifies or modifies the transaction information to impost to the institution. In order to prevent the transaction information from being falsified or modified, encryption and decryption are needed while store and in the process of double-checking the transaction information.

The present invention provides a system and method for managing and securing transaction information via a third party. The transaction is conducted between a buyer and a seller. In contrast to the prior art, the system and method of the present invention manage and protect the transaction information by a fair third party, which is excluded from the transaction. More specifically, the encryption and decryption of the private information associated with the buyer (consumer) are not executed by the seller (merchant), but executed by the third party. Therefore, the seller does not obtain the buyer's private information; hence has no way to falsify or modify the information. What follows will describe the preferred embodiment of the present invention to sufficiently illustrate the characteristics and advantages of the present invention.

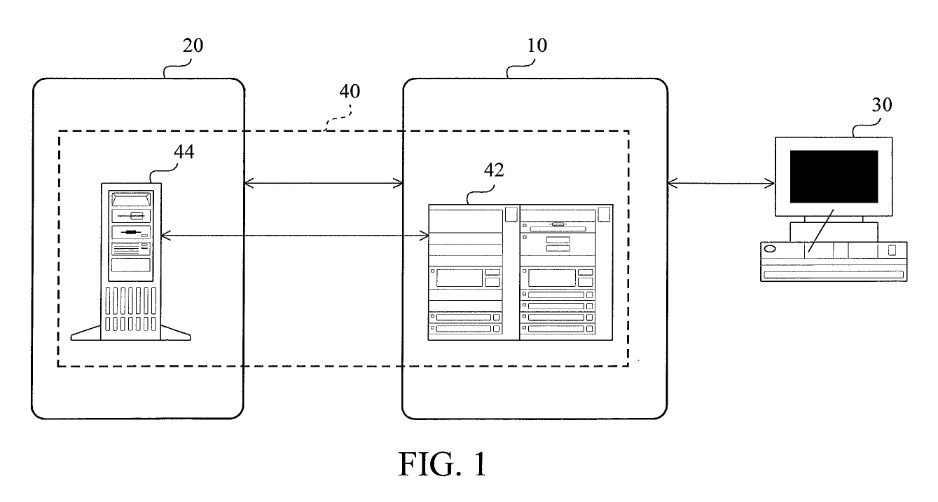

Referring to FIG. 1, FIG. 1 is a schematic diagram of a data processing system 40 according to the preferred embodiment of the present invention. The data processing system 40 manages and protects transaction information by a third party 10. The transaction is conducted between a seller 20 (e.g. merchant) and a buyer (consumer). The buyer connects and communicates with the third party 10 by a network apparatus 30 and transmits the transaction information to the third party 10. The seller 20 also connects and communicates with the third party 10.

As shown in FIG. 1, the data processing system 40 comprises a first processing apparatus 42 and a second processing apparatus 44. The third party 10 operates the first processing apparatus 42. The first processing apparatus 42 may be installed in the third party 10. The seller 20 operates the second processing apparatus 44. And the second processing apparatus 44 may be installed in the seller 20. The second processing apparatus 44 is connected with the first processing apparatus 42.

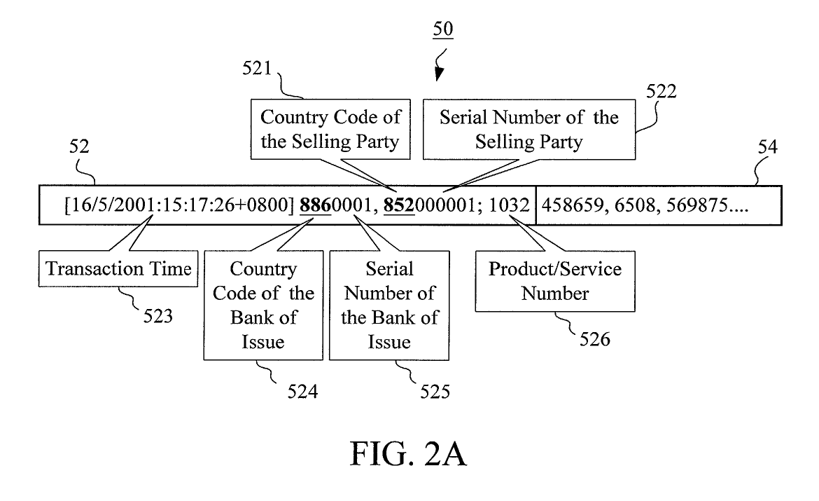

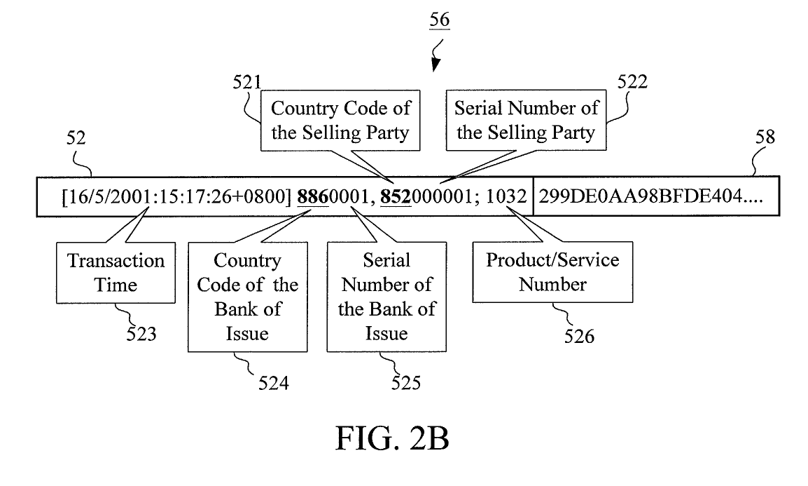

Referring to FIG. 2A and FIG. 2B, FIG. 2A is a schematic diagram of the unencrypted transaction information. FIG. 2B is a schematic diagram of the encrypted transaction information. A transaction information 50 comprises a first information 52 associated with the seller 20 and a second information 54 associated with the buyer. The fist processing apparatus 42 is used to encrypt the second information 54 based on the first information 52 for generating an encrypted second information 58 as shown in FIG. 2B. The transaction information 56 comprises a first information 52 associated with the seller and an encrypted second information 58 obtained from encrypting the second information 54.

Overall, there are two major objectives concluded from the above description. First, securing buyer information throughout the process of encryption so it will not be disclosed. Second, retaining the information associated with the seller, which serves as an information classification and guidance in the process of managing and storing. Besides, such classifying and guiding information will not be associated with seller so the information security issue is being considered.

The encrypted second information 58 is encrypted based on the first information 52. It means that the encrypting logics relate to the content of the first information 52. In this way, the encrypted second information 58 and the first information 52 are closely related. Therefore, if the first information 52 or the encrypting second information 58 is changed, the whole information cannot be decrypted.

What follows is an example of transaction made by a credit card to describe the transaction information 50 and the transaction information 56 encrypted by the first processing apparatus 42. As shown in FIG. 2A and FIG. 2B, the first information 52 associated with the seller comprises country code 521, serial number 522, etc. of the seller. In addition, in order to manage easily and avoid being confused between both transaction information 50 and the encrypted transaction information 56 later and quickly refer the encrypted transaction information 56 in the proceeding process; the first information 52 has index function to direct to the transaction. The index information comprises a transaction time 523, country code 524 of the issued bank, serial number 525 of the issued bank and product/service number 526, etc. However, the index information doesn't include any information associated with the buyer.

After encryption, the first processing apparatus 42 transmits the first information 52 and the encrypted second information 58 to the second processing apparatus 44. Upon receiving, the second processing apparatus 44 stores the first information 52 and the encrypted second information 58.

When the seller 20 requests to check the transaction, the second processing apparatus 44 transmits the first information 52 and the encrypted second information 58 back to the first processing apparatus 42. When the first processing apparatus 42 receives the first information 52 and the encrypted second information 58 from the second processing apparatus 44, the first processing apparatus 42 decrypts the encrypted second information 58 based on the first information 52 to retrieve the transaction information. According to the retrieved transaction information, the first processing apparatus 42 generates a response information. The response information is responsive to the seller's request to check the transaction. The first processing apparatus 42 also transmits the response information to the second processing apparatus 44.

A practical example indicates that the response information comprises the amount of money associated with the transaction. Another example reveals that the response information comprises a confirmation of the transaction. In this case, notification of “yes” or “no” significantly represents “truth” or “false” for the status of the transaction.

From the above description, it is clear that the seller 20 can't obtain the information associated with the buyer during the entire process. Because the transaction information 50 is a combination of the first information 52 and the second information 54. That means if the seller 20 or the second processing apparatus 44 changes the first information 52 or the encrypting second information 58, the first processing apparatus 42 cannot decrypt the whole transaction information or the decryption becomes invalid information. Therefore, the information associated with the buyer is secured and the rights of the buyer are protected.

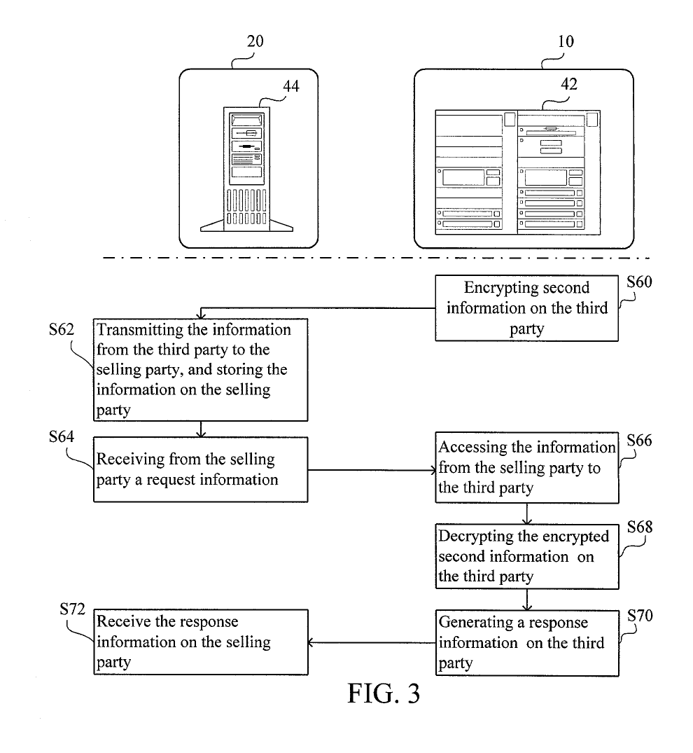

Please refer to FIG. 3. FIG. 3 is a flow chart of the data processing procedures o according to a preferred embodiment of the present invention. The data processing procedures of the data processing system 40 comprise:

Step S60: at the third party 10, encrypting the second information 54 based on the first information 52 to generate an encrypted second information 58. Step S62, transmitting the first information 52 and the encrypted second information 58 from the third party 10 to the seller 20, and storing the first information 52 and the encrypted second information 58 on the seller 20.

Step S64: receiving a request information from the seller 20. The request information represents a request to check the transaction.

Step S66: accessing the first information 52 and the encrypted second information 58 from the seller 20 and then transmitting those information to the third party 10.

Step S68: at the third party 10, decrypting the encrypted second information 58 based on the first information 52 to retrieve the transaction information 50.

Step S70: at the third party 10, generating a response information according to the retrieved transaction information 50.

Step S72: transmitting the response information to the seller 20.

In the system and method for managing and securing transaction information via a third party according to the present invention, the transaction information of each transaction can be properly managed and secured. Moreover, the rights of the buyer, the seller, and the institute involved in money transfer or authorization can be protected, which can lead to a better development of the Internet transaction.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system for managing and securing a transaction information associated with a transaction via a third party, the transaction being conducted between a buying party and a selling party, the transaction information comprising a first information associated with the selling party and a second information associated with the buying party, said system comprising:
a first processing apparatus, operated by the third party, for
encrypting the second information based on the first information to generate an encrypted second information, and
transmitting the first information and the encrypted second information out;
a second processing apparatus, operated by the selling party and linking to the first processing apparatus, for
storing the first information and the encrypted second information transmitted from the first processing apparatus, and
transmitting the first information and the encrypted second information back to the first processing apparatus when the selling party requests to check the transaction,
wherein when the first processing apparatus receives the first information and the encrypted second information transmitted back, the first processing apparatus decrypts the encrypted second information based on the first information to retrieve the transaction information, generates, according to the retrieved transaction information, a response information responsive to request to check the transaction, and transmits the response information to the second processing apparatus; and
whereby the transaction information is prevented from being altered by the selling party.

2. The data processing system of claim 1, wherein the response information comprises an information for identifying the transaction.

3. The data processing system of claim 1, wherein the response information comprises an information indicating an amount of money associated with the transaction.

4. The data processing system of claim 1, wherein the first information also comprises an index information for directing to the transaction.

5. A data processing method for managing and securing a transaction information associated with a transaction via a third party, the transaction being conducted between a buying party and a selling party, the transaction information comprising a first information associated with the selling party and a second information associated with the buying party, said method comprising the steps of:
(a) encrypting the second information based on the first information to generate an encrypted second information on the third party;
(b) transmitting the first information and the encrypted second information from the third party to the selling party, and storing the first information and the encrypted second information on the selling party;
(c) receiving from the selling party a request information representing a request to check the transaction;
(d) accessing the first information and the encrypted second information from the selling party to the third party;
(e) decrypting the encrypted second information based on the first information to retrieve the transaction information on the third party;
(f) according to the retrieved information, generating a response information responsive to the request information on the third party; and
(g) transmitting the response information to the selling party;
whereby the transaction information is prevented from being altered by the selling party.

6. The data processing method of claim 5, wherein the response information comprises an information for identifying the transaction.

7. The data processing method of claim 5, wherein the response information comprises an information indicating an amount of money associated with the transaction.

8. The data processing method of claim 5, wherein the first information also comprises an index information for directing to the transaction.
